(19) United States
(12) Patent Application Publication
(10) Pub. No.: US 2004/0103345 A1
(43) Pub. Date: May 27, 2004

(54) Method, apparatus and system for ensuring reliable power down of a personal computer

(76) Inventor: Robert A. Dunstan, Forest Grove, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/319,932

(22) Filed: Nov. 21, 2002

(51) Int. Cl. H04L 1/22

(52) U.S. Cl. 714/24

(57) ABSTRACT

A watchdog timer monitors a personal computer (“PC”) power down process. In one embodiment of the present invention, when a user issues a command (via the operating system) to power down the PC, the system firmware activates a watchdog timer. If the watchdog timer expires prior to the successful shutdown of the PC, the watchdog timer may cause the PC to power down.

### FIELD OF THE INVENTION

The present invention relates to the field of computer power management, and, more particularly to a technique for ensuring that a computer system reliably enters into a power off state.

### BACKGROUND

Personal computers (“PCs”) today may be shutdown manually, i.e. by the user simply reaching over and turning off the power on the computer, or indirectly via the PC's operating system (“OS”). Users are encouraged to use the latter method, to ensure that the OS is able to shutdown any active processes in an orderly manner prior to powering down the system. Thus, for example, on PCs running Microsoft's Windows™ family of operating systems, users may power down their PCs by selecting the “Start” menu item, followed by the “Shutdown” command.

Unfortunately, however, users who power down their systems via the OS cannot be guaranteed that the PC will actually shutdown. Frequently, the OS encounters problems during the shutdown process, resulting in the power remaining on instead of shutting off. This continued power consumption is especially detrimental to PC notebook users who may shutdown their system and store their notebook in a carrying case, only to discover a few hours later that the battery on the notebook is dead because the notebook never actually powered off.

### BRIEF DESCRIPTION OF THE DRAWINGS

The present invention is illustrated by way of example and not limitation in the figures of the accompanying drawings in which like references indicate similar elements, and in which:

FIG. 1 is a flow diagram illustrating a known personal computer power down process;

FIG. 2 is a flow diagram illustrating one embodiment of the present invention; and

FIG. 3 is a conceptual illustration of a system according to one embodiment of the present invention.

### DETAILED DESCRIPTION

Embodiments of the present invention ensure that a PC powers down properly when a user issues a shutdown command. Unless otherwise specified, any references in the present specification to the phrase “shutdown” and/or “power down” shall mean removing power from a PC system, e.g., changing the PC system state from an “on” state to a “hibernate” state and/or a “soft off” state. When transitioning to a soft off state, the system shuts down all active processes and flushes the disk cache prior to powering down. When transitioning to a hibernate state, on the other hand, the system first writes all system and application state information to the PC hard drive prior to powering down. In the latter scenario, when the power is turned back on, the saved system and application information may be used to automatically restore the PC to its configuration immediately prior to entering hibernation.

Reference in the specification to “one embodiment” or “an embodiment” of the present invention means that a particular feature, structure or characteristic described in connection with the embodiment is included in at least one embodiment of the present invention. Thus, the appearances of the phrases “in one embodiment” “according to one embodiment” or the like appearing in various places throughout the specification are not necessarily all referring to the same embodiment.

Embodiments of the present invention ensure that a PC reliably powers down when instructed to do so by a user. In one embodiment, the PC may be running an Advanced Configuration and Power Interface (“ACPI”) compliant operating system. ACPI Version 2.0 (July 2000) is an open industry standard specification co-developed by Compaq™ Corporation, Intel® Corporation, Microsoft™ Corporation, Phoenix™ Technologies and Toshiba™ Corporation. ACPI (all versions, including and up to the current Version 2) allows PC vendors (including Original Equipment Manufacturers (“OEMs”) and BIOS vendors) to implement a standardized power management scheme by replacing previous power management schemes such as Advanced Power Management (“APM”) application programming interfaces (“APIs”), Plug and Play Basic Input-Output System (“PNPBIOS”) APIs and Multiprocessor Specification (“MPS”) tables with an OS-directed power management scheme.

More specifically, ACPI introduced the concept of “control methods” which provide a layer of abstraction that enables OEMs and BIOS vendors to write code (control methods) contained within the PC's BIOS. These control methods may be executed by an ACPI interpreter under the control of the OS to perform specific system tasks such as starting up and shutting down and/or changing power states of devices in the PC. In the Windows environment, for example, Prepare to Sleep (“_PTS”) is an ACPI control method that handles all the pre-shutdown procedures needed by a particular PC platform as a PC prepares to enter a sleep state (e.g. hibernate and/or shutdown). In ACPI terminology, these system “sleep” states may also be referred to as S0 (“on”), S4 (“hibernate”) and S5 (“soft off”).

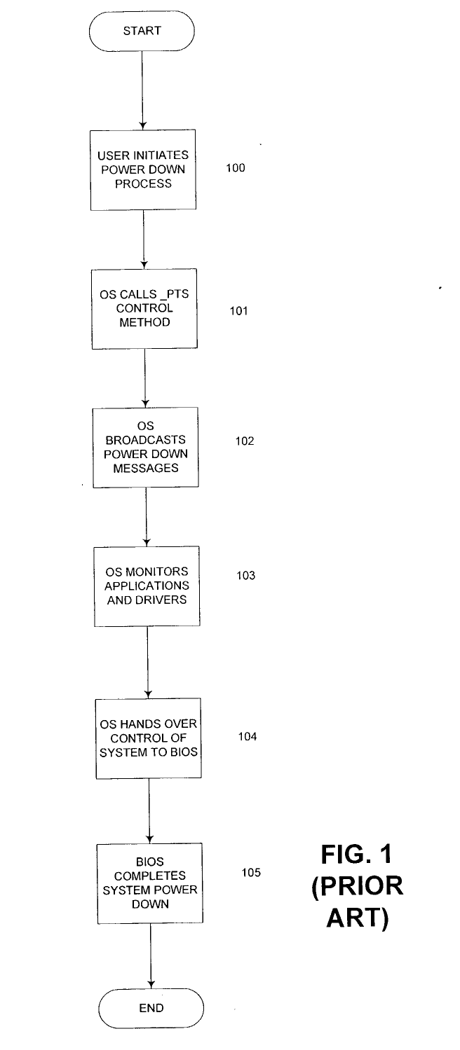

FIG. 1 illustrates a known process of powering down a PC running an ACPI-compliant OS. Although the operations may be described as a sequential process, many of the operations may in fact be performed in parallel or concurrently and/or the order of the operations may be re-arranged. Additionally, although the following description assumes an ACPI-compliant OS, it will be apparent to one of ordinary skill in the art that embodiments of the invention may be modified for a variety of operating systems and/or other power management systems.

As illustrated, when a user initiates the power down process in 100 (i.e. instructs the system to enter either an S4 (hibernate) or an S5 (soft off) state), the OS calls the _PTS control method in 101. The OS also begins to broadcast power down messages in 102 to any active applications and drivers. The OS continues to monitor applications and drivers in 103 until there are no longer any active processes. The OS may then hand over control of the system to the system firmware in 104 (i.e. initiate the sleep transition by programming the SLP_TYP field with the desired sleep state and setting the SLP_EN bit), and the system firmware may complete the system power down in 105. “System firmware” as used herein shall include traditional basic input-output systems and other platform firmware (hereafter collectively referred to as “BIOS”).

It is known in the art, however, that in certain instances, an application or driver may ignore the messages from the OS and attempt to remain active. Thus, for example, the OS may continue to broadcast power down messages and the application and/or driver may continuously ignore the messages. In this situation, the PC may be locked into a cycle, i.e. loop through 102 and 103, and never complete 104 and 105. The PC therefore does not power down and instead continues to consume power in an SO state.

Embodiments of the present invention utilize a “watchdog timer” (“WDT”) in conjunction with the _PTS control method and the PC BIOS to ensure that PCs running ACPI-compliant operating systems are not stuck in the loop described above and instead power down completely. WDTs are independent timer mechanisms designed to be periodically serviced (i.e. reset) to prevent them from expiring. If one or more applications, drivers and/or operating systems prevent the WDT from being periodically serviced, the WDT expires and takes an action, such as resetting the computer system. In order to function properly, these mechanisms are independent of the OS, the PC's central processing unit (“CPU”) and/or the state of any other hardware device on the PC.

WDTs may react differently to different situations. For example, a WDT may be designed to monitor an application executed by an OS, and terminate the application if the application fails to respond within a predetermined period of time. Design and implementation of WDTs are generally known in the art and further description of such is omitted herein in order not to unnecessarily obscure the present invention. An example of a WDT is the Total Cost of Ownership (“TCO”) WDT embedded in Intel® Corporation's I/O Controller Hub (“ICH”) chipset. It will be readily apparent to those of ordinary skill in the art that embodiments of the present invention are not limited to the TCO WDT, and that any WDT may be utilized.

According to embodiments of the present invention, the functionality of a WDT may be used to monitor a PC's power down sequence. More specifically, on a PC running an ACPI-compliant OS, the BIOS may be modified to activate a WDT when a power down process is initiated. If the WDT expires prior to the successful shutdown of the PC (i.e. the _PTS instructions or the subsequent OS operations are not able to complete execution), the WDT may cause the PC to power down in a number of different ways. For example, in one embodiment, the WDT may set a flag for the BIOS (i.e., inform the BIOS to take appropriate action) and reset the system. In this embodiment, during the new boot cycle (i.e. when the system is starting up again), the BIOS encounters the flag and causes the PC to power down.

In an alternate embodiment, however, expiration of the WDT may cause the PC to shutdown directly (i.e. without intervention from the BIOS). In yet another embodiment, upon expiration, the WDT may issue an interrupt. Implementation of interrupts in PCs is well known in the art and further description thereof is omitted herein in order not to unnecessarily obscure the invention. The interrupt may, for example, be a non-maskable interrupt (“NMI”), such as a System Management Interrupt (“SMI”). The interrupt handler may then write to the SLP_EN bit and complete the system power down. Embodiments of the present invention thus effectively eliminate the problem described above wherein the power down process remains under the control of the OS and may never complete execution.

According to other embodiments, the WDT may be activated and serviced by software such as a driver. It will be readily apparent to those of ordinary skill in the art that a driver according to embodiments of the invention may be implemented on a variety of operating systems, including operating systems that do not support ACPI or any other power management system. In one embodiment, the driver may be designed to respond to an OS shutdown broadcast messages. The driver may, for example, directly access and activate the WDT. Alternatively, the driver may invoke the _PTS control method or a similar control method. In other embodiments, the driver may use a proprietary scheme to give control of the WDT to the PC's BIOS. For example, the driver may generate a software interrupt, and the software interrupt handler may activate the WDT. Use of software interrupts are well known in the art and further descriptions of such are omitted herein in order not to unnecessarily obscure embodiments of the present invention.

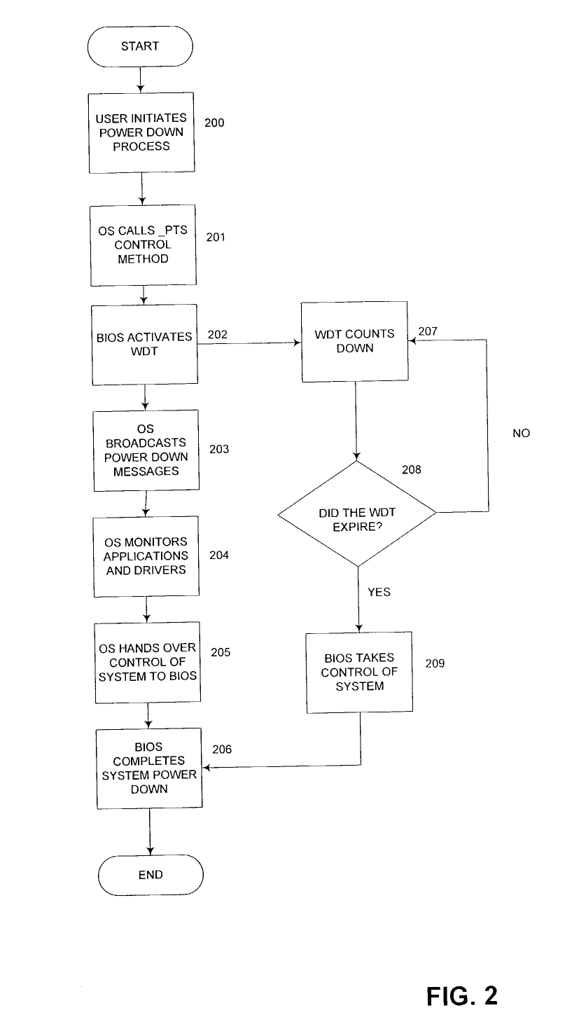

FIG. 2 is a flow diagram illustrating an embodiment of the present invention in further detail. As in FIG. 1, although the following operations may be described as a sequential process, many of the operations may in fact be performed in parallel or concurrently. In addition, the order of the operations may be re-arranged without departing from the spirit of embodiments of the invention. As will be readily obvious to those of ordinary skill in the art, although the following description assumes an ACPI-compliant OS, embodiments of the invention may be modified for operating environments complaint with other power management systems. Additionally, although the following description assumes a _PTS control method, alternate control methods and/or software (e.g. a driver) may also be utilized without departing from the spirit of embodiments of the present invention.

According to one embodiment of the present invention, when a user initiates a power down request in 200, the OS calls the _PTS control method in 201. Execution of the _PTS may be used by the BIOS to detect a power down request and to activate a WDT in 202 and the WDT begins to countdown in 207. The OS also begins to broadcast power down messages in 203 to any active applications and drivers. While the WDT counts down, the OS continues to monitor applications and drivers in 204. If the active applications and drivers are properly shut down, the OS hands over control of the system to the BIOS in 205. The BIOS then completes the normal system power down process in 206.

The WDT countdown in 207 continues independent of the OS activity. According to one embodiment, the WDT may be a TCO timer. The TCO timer has a predetermined expiration value. Thus, for example, the TCO timer may expire when it counts down to a predetermined expiration value of two minutes. It will be apparent to those of ordinary skill in the art that although the above example assumes an expiration value of two minutes, the TCO timer expiration may be set to any value. Upon expiration, the WDT may be designed to perform a specific task. In one embodiment, the specific task the WDT performs is to cause the OS to reset the system, thus giving control to the system's BIOS. In an alternate embodiment, upon expiration, the WDT may power down the system. In yet another embodiment, upon expiration, the WDT may issue an NMI, which may write to the SLP_EN bit and complete the system power down.

Accordingly, if the WDT in FIG. 2 reaches its predetermined countdown value, it may determine whether its countdown has expired in 208. If the countdown has not yet expired, the WDT may continue to countdown in 207. If, however, the WDT countdown is deemed expired in 208, the WDT may cause the BIOS to automatically take control of the system in 209 and force a power down of the PC in 206. It will be apparent to those of ordinary skill in the art that the events in 206 may overlap with certain events in 209, i.e. certain events that occur when the BIOS takes control of the system in 209 may in fact be the same events that occur when the BIOS completes the system power down in 206.

As previously described, according to one embodiment, in order for the BIOS to take control of the system, the WDT may issue an interrupt. The interrupt handler may write to the SLP_EN bit and complete the system power down. According to an alternate embodiment, the WDT may force the system to reset. System resets are known to those of ordinary skill in the art and the details thereof are omitted herein in order not to unnecessarily obscure the invention. In yet another embodiment, when resetting the system, the WDT may also set a flag for the BIOS. During the new boot cycle, the BIOS may encounter this flag and cause the PC to power down.

As will be readily obvious to those of ordinary skill in the art, embodiments of the present invention thus only take action when there is a problem with the PC power down process. If the PC power down sequence does not encounter any problem, embodiments of the present invention will not have any impact on the system because the PC may shutdown prior to the WDT expiring. If, however, the PC power down sequence does encounter a problem and the WDT expires, then embodiments of the present invention ensure that the system powers down as described above.

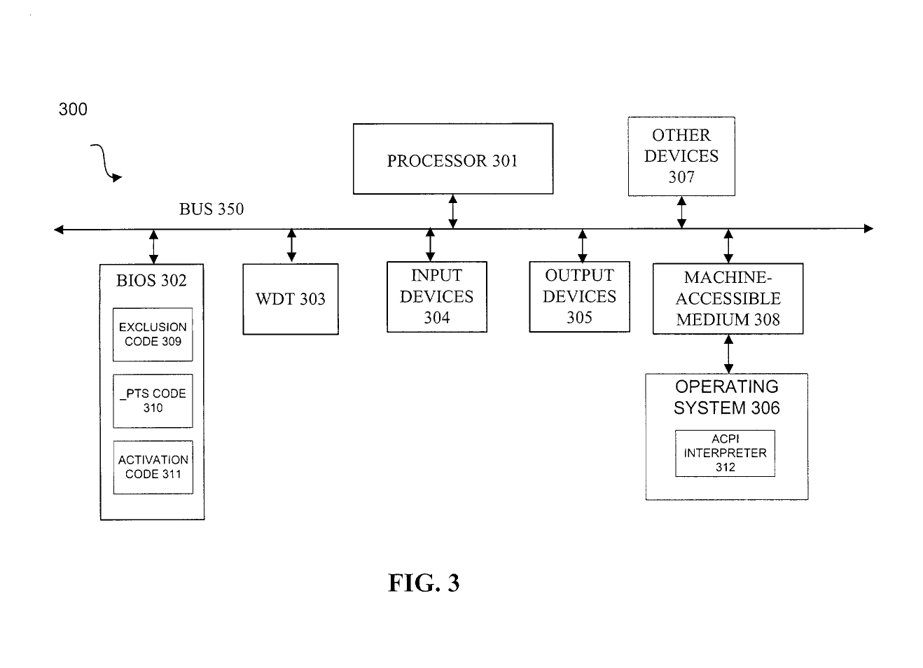

FIG. 3 is a conceptual illustration of a system (“System 300”) according to one embodiment of the present invention. Although the above description assumes that System 300 is a PC, in various embodiments of the present invention, System 300 may include workstations, servers and/or notebooks, laptops, personal digital assistants and other such computing devices. Specifically, as illustrated, System 300 may include one or more processors (collectively “Processor 301”), BIOS 302 (including Exclusion Code 309, _PTS Code 310 and Activation Code 311) and WDT 303. Processor 301 may be coupled to a Bus 350 to communicate information between the Processor 301 and other components in System 300.

Also coupled to Bus 350 may be one or more input devices 304 (collectively “Input Device 304”), such as a keyboard and/or a cursor control device, one or more output devices 305 (collectively “Output Device 305”), such as a monitor and/or printer, an ACPI-compliant OS 306 such as the Windows (including ACPI Interpreter 312), Other Devices 307 (including hardware devices such as memory controllers, graphics controllers, bus bridges, as well as software drivers), and one or more machine-accessible media (collectively “Machine-Accessible Medium 308”). As used in this specification, Machine-Accessible Medium 308 includes any mechanism that stores and/or transmits information in any form accessible by a machine, the machine-accessible medium including but not limited to, recordable/non-recordable media (such as read only memory (ROM), random access memory (RAM), magnetic disk storage media, optical storage media and flash memory devices), as well as electrical, optical, acoustical or other form of propagated signals (such as carrier waves, infrared signals and digital signals). As used in this specification, a “machine” includes, but is not limited to, any data processing device with one or more Processors 301. In one embodiment, OS 306 may be accessed via Machine-Accessible Medium 308 and executed by Processor 301.

When a user issues a power down command, OS 306 calls the PTS control method (illustrated as _PTS Code 310”). More specifically, OS 306 invokes ACPI Interpreter 312 to interpret _PTS Code 310. OS 306 also begins to broadcast power down messages to any active applications and drivers. In one embodiment, Activation Code 311 in BIOS 302 activates WDT 303. WDT 303 may comprise an existing watchdog timer circuit, such as Intel's TCO WDT, used by the PC for other purposes. BIOS 302 may include code that activates WDT 303 and retains control over WDT 303 for the duration of the power down process. In this embodiment, it is critical for BIOS 302 to retain control over WDT 303 for the duration of the power down process to eliminate any possibility that other applications and/or the OS may attempt to override WDT 303.

In embodiments of the present invention, BIOS 302 may retain control over WDT 303 by adding Exclusion Code 309 to BIOS 302. Although in FIG. 3, Exclusion Code 309 is illustrated as being contained within BIOS 302, separate from _PTS Code 310 and Activation Code 311, it will be readily apparent to those of ordinary skill in the art that Exclusion Code 309, PTS Code 310 and/or Activation Code 311 may also be contained within the same code modules. In one embodiment, Exclusion Code 309 is a separate code module and is activated when _PTS Code 310 is invoked. Exclusion Code 309 may set a trap on all accesses to WDT 303. In one embodiment, the trap may result in an SMI which is not visible to OS 306. The SMI causes the system to begin executing in System Management Mode (“SMM”). While executing in SMM, only BIOS 302 may access WDT 303. In an alternative embodiment, WDT 303 may be designed solely for use by BIOS 302 to monitor the PC power down process. WDT 303 may therefore be visible and accessible only to BIOS 302, thus eliminating the need to hide WDT 303 from the OS and other applications and/or devices.

According to one embodiment of the present invention, WDT 303 begins to countdown while OS 306 continues to monitor applications and drivers. If WDT 303 expires before the power down process is completed, BIOS 302 may automatically take over and force a power down of the PC. If, however, all of the applications and drivers shutdown properly prior to the expiration of WDT 303's countdown, OS 306 may hand over control of the system to BIOS 302 and BIOS 302 may complete the system power down.

In the foregoing specification, the invention has been described with reference to specific exemplary embodiments thereof. It will, however, be appreciated that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A method for ensuring power down of a machine, comprising:
receiving a power down request;
activating a watchdog timer (WDT) having a predetermined expiration value; and
enabling the machine to power down when the predetermined expiration value of the WDT is reached.

2. The method according to claim 1 wherein activating the WDT further comprises:
receiving an instruction from a basic input output system (BIOS) to activate the WDT; and
starting the WDT to countdown to the predetermined expiration value.

3. The method according to claim 2 wherein receiving the power down request includes invoking an Advanced Configuration and Power Interface (ACPI) control method.

4. The method according to claim 3 wherein the ACPI control method is a _PTS control method.

5. The method according to claim 4 wherein receiving the power down request further comprises interpreting the _PTS control method contained within the BIOS.

6. The method according to claim 1 wherein enabling the machine to power down when the predetermined expiration value of the WDT is reached comprises at least one of:
the WDT powering down the machine;
the WDT setting a reset flag to be interpreted by the BIOS during a boot sequence, the BIOS capable of powering down the machine in response to the WDT reset flag; and
the WDT causing an interrupt, resulting in the BIOS powering down the machine.

7. The method according to claim 6 wherein the interrupt is a non-maskable interrupt (“NMI”).

8. The method according to claim 7 wherein the NMI is a System Management Interrupt (“SMI”).

9. The method according to claim 1 wherein activating the WDT further comprises a driver intercepting the power down request and accessing the WDT.

10. The method according to claim 9 wherein the driver accessing the WDT further comprises one of:
accessing the WDT directly;
accessing the WDT via an Advanced Configuration and Power Interface (ACPI) control method; and
accessing the WDT via a proprietary scheme.

11. A system for ensuring power down of a machine, comprising:
an operating system capable of receiving a power down request;
a processor capable of executing the operating system to fulfill the power down request;
a watchdog timer (WDT) having a predetermined expiration value; and
a basic input-output system (BIOS) containing code capable of activating the WDT when the operating system receives the power down request, the WDT capable of ensuring power down of the machine when the predetermined expiration value of the WDT is reached.

12. The system according to claim 11 wherein the BIOS is further capable of starting the WDT to countdown to the predetermined expiration value.

13. The system according to claim 11 wherein the power down request is an Advanced Configuration and Power Interface (ACPI) control method.

14. The system according to claim 13 wherein the ACPI control method is a _PTS control method.

15. The system according to claim 14 wherein the BIOS is further capable of containing code corresponding to the _PTS control method.

16. The system according to claim 15 further comprising an ACPI interpreter, the operating system capable of invoking the ACPI interpreter to interpret the code in the BIOS corresponding to the _PTS control method.

17. The system according to claim 11 wherein the WDT is capable of ensuring power down of the machine when the predetermined expiration value of the WDT is reached according to at least one of the following:
the WDT powers down the machine;
the WDT sets a reset flag to be interpreted by the BIOS during a boot sequence, the BIOS capable of powering down the machine in response to the WDT reset flag; and
the WDT causes an interrupt, resulting in the BIOS powering down the machine.

18. The system according to claim 17 wherein the interrupt is a non-maskable interrupt (“NMI”).

19. The system according to claim 18 wherein the NMI is a System Management Interrupt (“SMI”).

20. A system for ensuring power down of a machine, comprising:
an operating system capable of receiving a power down request;
a processor capable of executing the operating system to fulfill the power down request;
a watchdog timer (WDT) having a predetermined expiration value; and
a driver containing code capable of activating the WDT when the operating system receives the power down request, the WDT capable of ensuring power down of the machine when the predetermined expiration value of the WDT is reached.

21. The system according to claim 20 wherein the driver is further capable of:
accessing the WDT directly;
accessing the WDT via an Advanced Configuration and Power Interface (ACPI) control method; and
accessing the WDT via a proprietary scheme.

22. A basic input-output system (BIOS), comprising:
activation code capable of activating a watchdog timer (WDT) to ensure a machine powers down.

23. The BIOS according to claim 16 further comprising exclusion code capable of intercepting all access requests to the WDT.

24. The BIOS according to claim 16 further comprising control method code, the control method capable of being invoked by an operating system.

25. The BIOS according to claim 18 wherein the control method is an Advanced Configuration and Power Interface control method.
